(19) United States
(12) Patent Application Publication
(10) Pub. No.: US 2007/0076695 A1
(43) Pub. Date: Apr. 5, 2007

(54) Method and apparatus for translating a telephone number to a packet network address in a soft modem

(76) Inventors: Christopher Chu, Circle Lakewood, CO (US); Robert Seibel, Waretown, NJ (US); Mukund Sundararajan, Sayreville, NJ (US)

Correspondence Address: RYAN, MASON & LEWIS, LLP, 1300 POST ROAD, SUITE 205, FAIRFIELD, CT, 06824, US

(21) Appl. No.: 11/241,733

(22) Filed: Sep. 30, 2005

(51) Int. Cl. H04L 12/66

(52) U.S. Cl. 370/352

(57) ABSTRACT

Methods and apparatus are provided for translating a telephone number to a packet network address in a soft modem. A connection over a network is established to a device by receiving a request to establish a connection over a network to a device, the request including a telephone number associated with the device; accessing a database, such as a Domain Name Server, to translate the telephone number to a packet network address; and establishing a connection to the device over a packet network using the packet network address. The Domain Name Server can optionally map the telephone number to the packet network address.

### FIELD OF THE INVENTION

The present invention relates generally to the field of soft modems, and more particularly, to techniques for translating telephone numbers to packet network addresses, such as Internet Protocol (IP) addresses, in a soft modem.

### BACKGROUND OF THE INVENTION

Traditionally, a computing system, such as a personal computer, connected to a network, such as the network of an Internet Service Provider (ISP), by using a hardware modem associated with the computing system to make a connection over the Public Switched Telephone Network (PSTN) to a modem of the ISP. Generally, the hardware modem on the computing system dialed a telephone number that identified the modem of the ISP. Thus, traditional hardware modems employ PSTN routing functionality to make end-to-end connections over a network.

Increasingly, however, enterprises and individuals are eliminating hardware modems and are migrating from modem-based networks to packet networks, such as IP-based networks. A number of techniques have been proposed or suggested for replacing hardware modems by a software modem instance. One particular problem for modem-based applications that are migrated to packet networks, however, is updating the telephone number routing employed by traditional hardware modems in the PSTN with an address that is appropriate in a packet network.

One proposed technique simulates the hardware modem in various ways utilizing standard hardware (i.e., a terminal server) and new modem software. However, these solutions have not found a way to replace the required PSTN telephone number routing functionality. Generally, most existing techniques rely on the customer to manually update the existing telephone numbers in modem script sources or in modem-based application databases to IP addresses, generally in the form of IPAddress:Port pairs. Such manual solutions can be very confusing, hard to update and costly when there are many telephone numbers involved.

E164.org is another solution that provides a directory of telephone numbers that can be reached over the Internet. Generally, E164.org allows telephone numbers to be mapped, for example, to email addresses, websites (URL) or Voice over IP (VOIP) addresses using DNS entries. For a more detailed discussion of E164.org, see, for example, http://www.e164.org/. While E164.org provides an effective mechanism for routing a voice call to another device, based on an email address, URL or VoIP address, E164.org does not provide a solution to the modem elimination problem.

A need therefore exists for techniques for replacing existing hardware modems and transparently migrating modem-based applications to IP networks. A further need exists for techniques for updating the PSTN routing functionality that hardware modems rely on to make end-to-end connections.

### SUMMARY OF THE INVENTION

Generally, methods and apparatus are provided for translating a telephone number to a packet network address in a soft modem. According to one aspect of the invention, a connection over a network is established to a device by receiving a request to establish a connection over a network to a device, the request including a telephone number associated with the device; accessing a database, such as a Domain Name Server, to translate the telephone number to a packet network address; and establishing a connection to the device over a packet network using the packet network address.

The device can be, for example, a modem associated with a remote device. The Domain Name Server can optionally map the telephone number to the packet network address. The packet network can be an IP network, such as the Internet, and the packet network address can comprise an IP address, such as an IPAddress:Port pair.

A more complete understanding of the present invention, as well as further features and advantages of the present invention, will be obtained by reference to the following detailed description and drawings.

### BRIEF DESCRIPTION OF THE DRAWINGS

FIG. 1 illustrates two computing systems establishing a conventional modem connection over the Public Switched Telephone Network (PSTN);

FIG. 2 illustrates a network environment in which the present invention can operate;

FIG. 3 is a flow chart describing an exemplary implementation of a telephone number translation process incorporating features of the present invention; and

FIG. 4 is a sample table illustrating the Domain Name Server incorporating features of the present invention.

### DETAILED DESCRIPTION

The present invention improves on existing modem-elimination solutions by recognizing that IP-based software modems can rely on the DNS to map existing telephone numbers to packet network addresses, such as IP addresses (e.g., IPAddress:Port data), for each destination software modem instance. Thus, among other benefits of the present invention, telephones numbers are managed in soft modems as part of the DNS system, eliminating the need for a separate routing database. The present invention extends an IP-based modem software package to include a small DNS utility that allows the soft modem to map a telephone number to an IP address. In addition, the DNS utility can also allow the mapping data to be entered into the DNS database. The IP-based software modem can then continue to employ existing telephone numbers without any internal software/data source change.

FIG. 1 illustrates a first computing system 110, such as a personal computer, establishing a conventional modem connection to a second computing system 170, such as a server of an Internet Service Provider, over the Public Switched Telephone Network (PSTN) 150. The first computing system 110 employs a hardware modem 120 to connect to a hardware modem of the second computing system 170. It is noted that the modems 120, 160 may be independent devices, as shown in FIG. 1, or integrated with the respective computing system 110, 170.

Typically, one or more applications on the first computing system 110 employ the modem 120 to establish a connection using one or more user-supplied PSTN telephone numbers. Generally, such applications send a message to the hardware modem 120 with the telephone number of the desired destination modem 160. The message complies with a modem protocol that is appropriate for the modem 120. The message initiates the modem 120 to establish the connection to the desired destination modem 160 using the provided telephone number, in a known manner.

As previously indicated, many modem-based applications are being migrated from modem-based networks to IP-based networks. When modem-based applications are migrated to IP-based networks, however, the telephone number routing employed by the traditional hardware modems 120, 160 in the PSTN 150 must be updated with an address that is appropriate in an IP network. The present invention provides an address mapping feature that allows a modem-based application to translate a telephone number to an IP address, for example, using Domain Name Server (DNS) name mapping functionality.

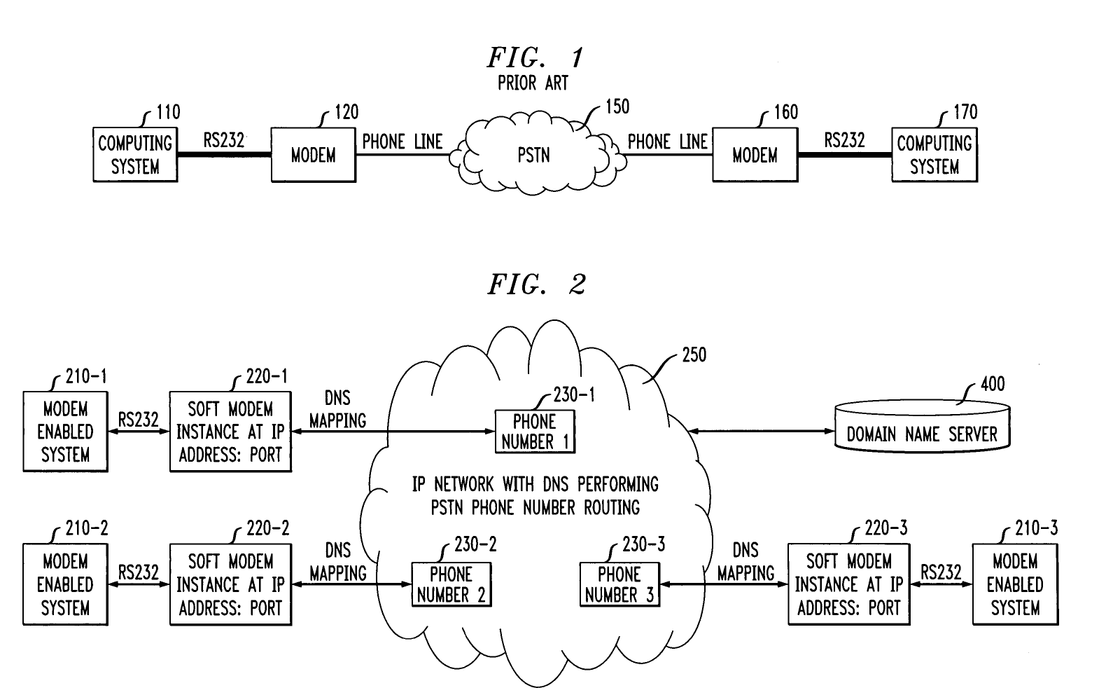

FIG. 2 illustrates a network environment in which the present invention can operate. As shown in FIG. 2, one or more computing systems 210-1 through 210-3, such as personal computers or application servers, establish a modem connection over a packet network 250, such as the IP-based Internet. The computing systems 210-1 through 210-3 employ a corresponding software modem 220-1 through 220-3 to connect to a destination modem 230-1 through 230-3, identified by a telephone number. It is noted that the modems 220 may be independent devices, as shown in FIG. 2, or integrated with the respective computing system 210. The modems 220 may be embodied as any IP-based software modem solutions, such as those commercially available from PC Micro or Tactical Software, LLC.

One or more applications on the computing systems 210 employ the corresponding modem 220 to establish a connection to a destination device 230 using one or more user-supplied PSTN telephone numbers. Generally, such applications send a message to the modem 220 with the telephone number of the desired destination device 230, in a similar manner to the conventional approach discussed above in conjunction with FIG. 1. In other words, the present invention allows existing modem-based applications to be migrated from modem-based networks to IP-based networks without requiring changes to the modem-based applications. The soft modem or terminal server can also be programmed to send to another IP address if the first IP address is unreachable. The application does not need to know that a connection to a backup server has occurred. For example, if an attempted connection to a first IP address fails, the soft modem can request an alternate address from the DNS for a backup IP address for the primary number. In this manner, the connection succeeds to the backup IP.

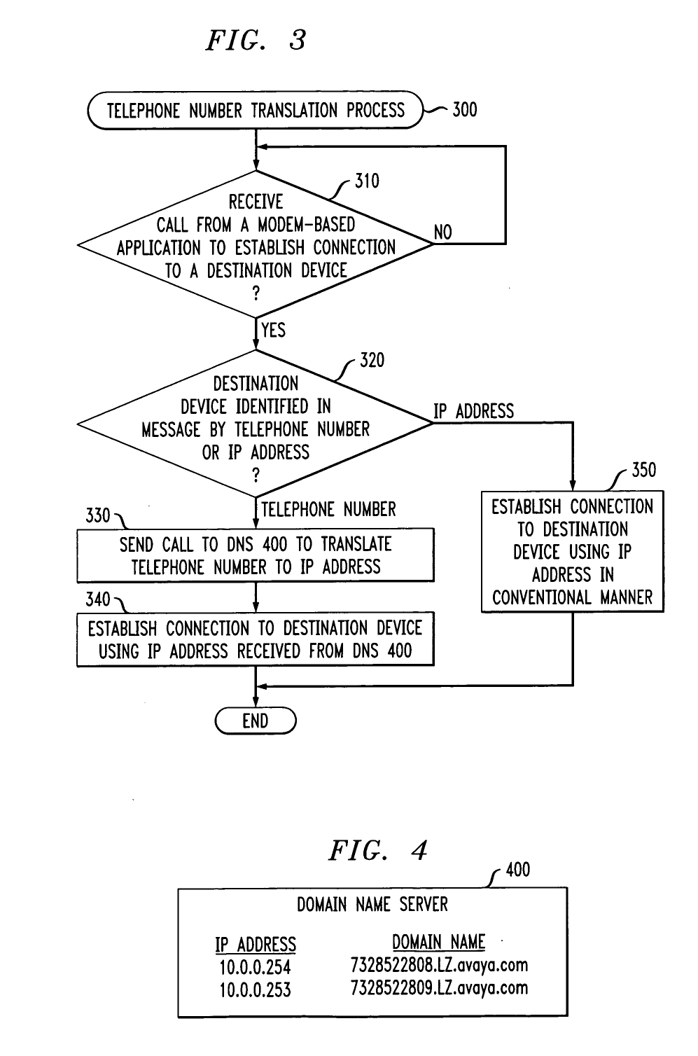

The message complies with a modem protocol that is appropriate for the modem 220. The message initiates the soft modem 220 to establish the connection to the desired destination device 230 using the provided telephone number. As discussed below in conjunction with FIG. 3, a soft modem 220 in accordance with the present invention employs a telephone number translation process 300 to translate the telephone number to an IP address. In one exemplary implementation shown in FIG. 2, the telephone number translation process 300 translates the telephone number to an IP address using the Domain Name Server 400 or a similar database. An exemplary embodiment of the Domain Name Server 400 is discussed below in conjunction with FIG. 4. Generally, the Domain Name Server 400 maps existing telephone numbers used by the modem-based applications to IP addresses, such as IPAddress:Port pairs.

According to one aspect of the present invention, each destination IP-based software modem instance 230, once instantiated, resides at an existing telephone number that is mapped by the DNS 400 to an IPAddress:Port pair. Thus, the IP-based modem software 300 on the source device can rely on the DNS 400 to route the connection to this telephone number. In this manner, there is no internal change to the software source or telephone number data.

FIG. 3 is a flow chart describing an exemplary implementation of a telephone number translation process 300 incorporating features of the present invention. The telephone number translation process 300 will be implemented by a soft modem 220 operating in accordance with the present invention. As shown in FIG. 3, the telephone number translation process 300 initially performs a test during step 310 until it is determined that a call has been received from a modem-based application to establish a connection to a destination device.

Once it is determined during step 310 that a call has been received from a modem-based application to establish a connection to a destination device, then a further test is performed during step 320 to determine if the destination device is identified in the message by a PSTN telephone number or an IP address. If it is determined during step 320 that the destination device is identified in the message by a PSTN telephone number, then a call is sent to the DNS 400 during step 330 in accordance with the present invention to translate the telephone number to an IP address. It is noted that an alternative client or server side database can also be employed. Thereafter, a connection is established to the destination device during step 340 using the IP address received from the DNS 400 in the previous step.

If, however, it is determined during step 320 that the destination device is identified in the message by an IP address, then a connection is established to the destination device during step 350 using the provided IP address, in a conventional manner.

FIG. 4 is a sample table illustrating the Domain Name Server 400. As previously indicated, the Domain Name Server 400 maps existing telephone numbers used by the modem-based applications to IP addresses, such as IPAddress:Port pairs. The exemplary records shown in FIG. 4 contain “A” records that are used by DNS servers to set a domain name to an IP address. As shown in FIG. 4, the exemplary Domain Name Server 400 comprises record pairs, where each record pair comprises an IP address and a corresponding domain name. Each exemplary IP address itself comprises a IPAddress:Port pair. It is recognized that a number of variations are possible, as would be apparent to a person of ordinary skill in the art.

Generally, any database that maps existing telephone numbers into IP addresses (e.g., IPAddress:Port pairs), can be employed. In this manner, the IP connection can be routed to a destination software modem instance to replace PSTN telephone number routing functionality when IP networks are used.

Among other benefits, the present invention does not require new routing data to be separately maintained for existing telephone numbers that associate with the hardware modems that are to be replaced. The existing telephone numbers are used as other names for the modem instances each of which acts as an IP endpoint. These telephone numbers and their mapping to IPAddress:Port just need to be recorded in the DNS or a similar database that can be accessed by the telephone number translation process 300.

System and Article of Manufacture Details

As is known in the art, the methods and apparatus discussed herein may be distributed as an article of manufacture that itself comprises a computer readable medium having computer readable code means embodied thereon. The computer readable program code means is operable, in conjunction with a computer system, to carry out all or some of the steps to perform the methods or create the apparatuses discussed herein. The computer readable medium may be a recordable medium (e.g., floppy disks, hard drives, compact disks, or memory cards) or may be a transmission medium (e.g., a network comprising fiber-optics, the world-wide web, cables, or a wireless channel using time-division multiple access, code-division multiple access, or other radio-frequency channel). Any medium known or developed that can store information suitable for use with a computer system may be used. The computer-readable code means is any mechanism for allowing a computer to read instructions and data, such as magnetic variations on a magnetic media or height variations on the surface of a compact disk.

The computer systems and servers described herein each contain a memory that will configure associated processors to implement the methods, steps, and functions disclosed herein. The memories could be distributed or local and the processors could be distributed or singular. The memories could be implemented as an electrical, magnetic or optical memory, or any combination of these or other types of storage devices. Moreover, the term “memory” should be construed broadly enough to encompass any information able to be read from or written to an address in the addressable space accessed by an associated processor. With this definition, information on a network is still within a memory because the associated processor can retrieve the information from the network.

It is to be understood that the embodiments and variations shown and described herein are merely illustrative of the principles of this invention and that various modifications may be implemented by those skilled in the art without departing from the scope and spirit of the invention.

We claim:

1. A method for establishing a connection over a network to a device, comprising:
receiving a request to establish a connection over a network to a device, said request including a telephone number associated with said device;
accessing a database to translate said telephone number to a packet network address; and
establishing a connection to said device over a packet network using said packet network address.

2. The method of claim 1, wherein said database comprises a Domain Name Server.

3. The method of claim 2, wherein said Domain Name Server maps said telephone number to said packet network address.

4. The method of claim 1, wherein said packet network address is an IP address.

5. The method of claim 4, wherein said IP address comprises an IPAddress:Port pair.

6. The method of claim 1, wherein said request is compliant with a modem communication protocol.

7. The method of claim 1, wherein said device is a modem associated with a remote device.

8. The method of claim 1, wherein said packet network comprises the Internet.

9. The method of claim 1, further comprising the step of establishing a connection to said device using another packet network address if said translated packet network address is unreachable.

10. A system for establishing a connection over a network to a device, comprising:
a memory; and
at least one processor, coupled to the memory, operative to:
receive a request to establish a connection over a network to a device, said request including a telephone number;
access a database to translate said telephone number to a packet network address;
and
establish a connection to said device over a packet network using said packet network address.

11. The system of claim 10, wherein said database comprises a Domain Name Server.

12. The system of claim 11, wherein said Domain Name Server maps said telephone number to said packet network address.

13. The system of claim 10, wherein said packet network address is an IP address.

14. The system of claim 10, wherein said request is compliant with a modem communication protocol.

15. The system of claim 10, wherein said device is a modem associated with a remote device.

16. The system of claim 10, wherein said packet network comprises the Internet.

17. The system of claim 10, wherein said processor is further configured to establish a connection to said device using another packet network address if said translated packet network address is unreachable.

18. An article of manufacture for establishing a connection over a network to a device, comprising a machine readable medium containing one or more programs which when executed implement the steps of:
receiving a request to establish a connection over a network to a device, said request including a telephone number associated with said device;
accessing a database to translate said telephone number to a packet network address; and
establishing a connection to said device over a packet network using said packet network address.

19. The article of manufacture of claim 18, wherein said database comprises a Domain Name Server that maps said telephone number to said packet network address.

20. The article of manufacture of claim 18, wherein said one or more programs which when executed further implement the step establishing a connection to said device using another packet network address if said translated packet network address is unreachable.
